(19) United States
(12) Patent Application Publication
(10) Pub. No.: US 2016/0371626 A1
(43) Pub. Date: Dec. 22, 2016

(54) MONITORING EVENTS IN A PROJECT OR ORGANIZATION

(71) Applicant: INTERNATIONAL BUSINESS MACHINES CORPORATION, Armonk, NY (US)

(72) Inventors: Sherif M. ALI, Dokki (EG); Hisham E. ELSHISHINY, Cairo (EG); Hanaa S. HAMMAD, Cairo (EG); Sivananthan PERUMAL, Bangalore (IN); Kassam M. VARVANI, Ontario (CA)

(21) Appl. No.: 14/980,481

(22) Filed: Dec. 28, 2015

(30) Foreign Application Priority Data
Jun. 19, 2015 (GB) 2015/002286

(51) Int. Cl. G06Q 10/06; G06Q 10/10

(52) U.S. Cl. CPC G06Q 10/063114; G06Q 10/103

(57) ABSTRACT

A method, system, and computer program product includes a processing device extracting content from a user's communications associated with a project, where the project includes events, and where the events are assigned to a user. The processing device monitors the extracted content and stores the extracted content in a repository for patterns. The processing device detects in the extracted content, the patterns associated with at least one of: a behavior of the user, the events, or execution of the events.

### PRIOR FOREIGN APPLICATION

This application claims priority from United Kingdom (GB) patent application number 2015/002286, filed Jun. 19, 2015, which is hereby incorporated herein by reference in its entirety.

### BACKGROUND

In any project or organization, events that are assigned to participating members need to be monitored. Existing project planning tools and organization tools do not address how project/organization events are created, monitored in near real time. Events to be carried out by a user need to be monitored based on various event parameters and the role of the user who is assigned to the event.

### SUMMARY

Shortcomings of the prior art are overcome and additional advantages are provided through the provision of a method of monitoring events performed by a user in a project. The method includes: extracting, by a processing device, content from a user's communications associated with a project, wherein the project comprises events, and wherein the events are assigned to a user; monitoring, by the processing device, the extracted content and storing the extracted content in a repository for patterns; and detecting, by the processing device, in the extracted content, the patterns associated with at least one of: a behavior of the user, the events, or execution of the events.

Computer program products and computer systems relating to one or more aspects are also described and claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts a block diagram of an event monitor system for monitoring events according to an embodiment of the present invention;

FIG. 2 illustrates data flows in an embodiment of the present invention;

FIGS. 3A and 3B are a flow chart depicting aspects of a method performed by an embodiment of the present invention;

FIG. 4 illustrates data flows to and from a configurator aspect of certain embodiments of the present invention;

FIG. 5 illustrates data flows to and from an event monitoring aspect of an embodiment of the present invention;

FIG. 6 illustrates data flows to and from a pattern finder aspect of an embodiment of the present invention;

FIG. 7 illustrates data flows to and from a content extractor aspect of an embodiment of the present invention;

FIG. 8 illustrates data flows to and from a public data extractor aspect of an embodiment of the present invention;

FIG. 9 illustrates data flows to and from a collaborator aspect of an embodiment of the present invention;

FIG. 10 illustrates data flows to and from a notification manager aspect of an embodiment of the present invention;

FIG. 11 depicts a flow chart that is an example of periodic updates to a self-learner aspect of an embodiment of the present invention;

FIG. 12 illustrates data flows to and from a self-learner aspect of an embodiment of the present invention; and

FIG. 13 shows a computer system in which aspects of some embodiments of the present invention may be implemented.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures. It should be understood that the Figures are merely schematic and are not drawn to scale.

Embodiments of the present invention relate to the monitoring of events in a project or organization, and more specifically, to detecting patterns associated with user behavior, events, and the execution of those events in a project or organization.

Embodiments of the present invention include an event monitor system to monitor events carried out by users in a project or an organization. An embodiment of the event monitor system of the present invention takes input from project plans, organization charts, one or more event repositories and a project charter and uses the event monitoring system's monitoring and scoring components to provide effective monitoring of events. In an embodiment of the present invention, the event monitor system also uses its patterns repository component to feed different patterns to monitoring, scoring, and self-learner components.

Embodiments of the present invention find patterns associated with events, execution of events and user behavior. These patterns are used by project planners in allocating events and in planning activities. In an embodiment of the present invention, a self-learning system uses the identified patterns and execution feedback to update the monitoring system.

Embodiments of the invention provide the advantages of reducing the amount of time spent by a project manager in monitoring a project, providing an interactive project dashboard at an organization level, increasing the monitoring effectiveness by integrating with public, social and human behavior data sources, providing near real-time update of the events in the dashboard, facilitating the project manager in project planning by recommending the right set of implementation patterns, and providing a flexible configuration wizard for the project manager to configure the events and owners. The term “monitoring” is used throughout to mean observing, detecting, recording as well as following the course of or progress of a path of one or more events.

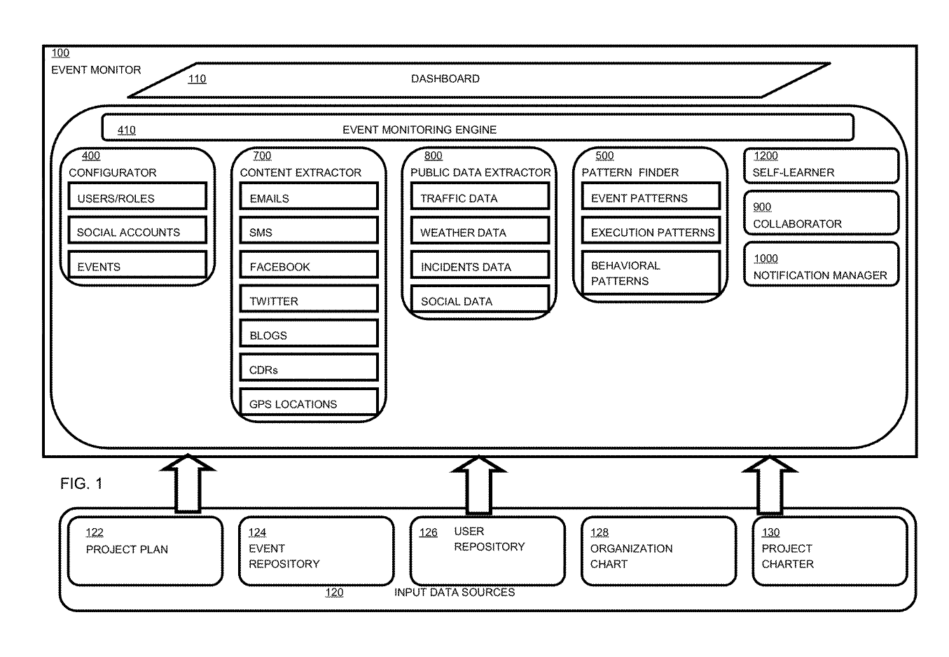

FIG. 1 shows a block diagram of a system for monitoring events according to an embodiment of the present invention. Event monitor 100 receives input from input data sources 120 such as project plan 122, event repository 124, user repository 126, organization chart 128, and project charter 130.

Project charter 130 is a contract or document that the project sponsor who requests the work and the project manager who arranges execution of the work use to agree on the initial vision of the project (scope, baseline, resources, objectives and the like) at a high level. In an embodiment of the present invention, the project charter 130 may include the rationale for the project, such as what business need does the project answer, the project objectives and success criteria, as well as the process to validate the success or otherwise of the project, a clear delimitation of project scope, a summary of the main aspects of the project, such as budget, timeline, leader and stakeholders, and an identification of the sponsors who decide to launch the project.

Project plan 122 is a document that the project manager builds to describe in detail the planning of the project and its organization. It describes the way the project will be managed and includes content such as schedule, scope/requirements/deliverables, cost, people, and skills needed. Depending on the size and stakeholders of the project, it may also include less important aspects such as communication, quality, and risks. The project management plan may consist of various documents, including but not limited to: the project statement of work (SoW), a cost/resource/time estimation for every activity, who will do what: roles and responsibilities, a name in front of each activity, a list of milestones, and a deadline in front of each activity.

In an embodiment of the present invention, an event repository 124 is a store of work items such as bugs, events, issues, defects, stories and the like. A user repository 126 is a data repository used to store user information such as, for example, user name, id, role, access rights, social networking accounts and other user accounts related to a project. This user repository 126 is used by the configurator 400 to retrieve user information when needed. The user repository 126 may be implemented using the Lightweight Directory Access Protocol (LDAP), which is an open, vendor-neutral, industry standard application protocol for accessing and maintaining distributed directory information services over an Internet Protocol (IP) network. An organization chart 128 identifies the structure of an organization and the relationships between its parts and the positions within the organization.

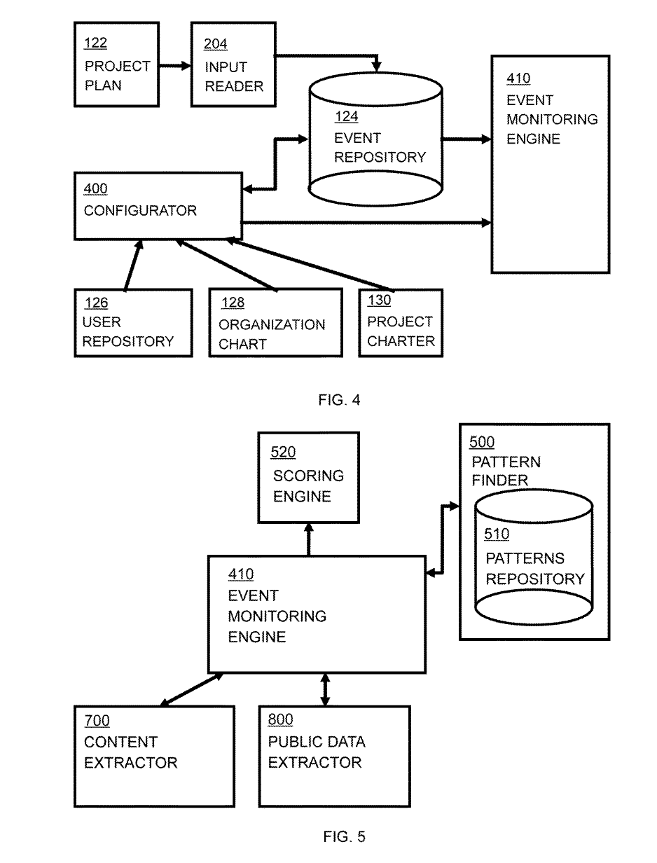

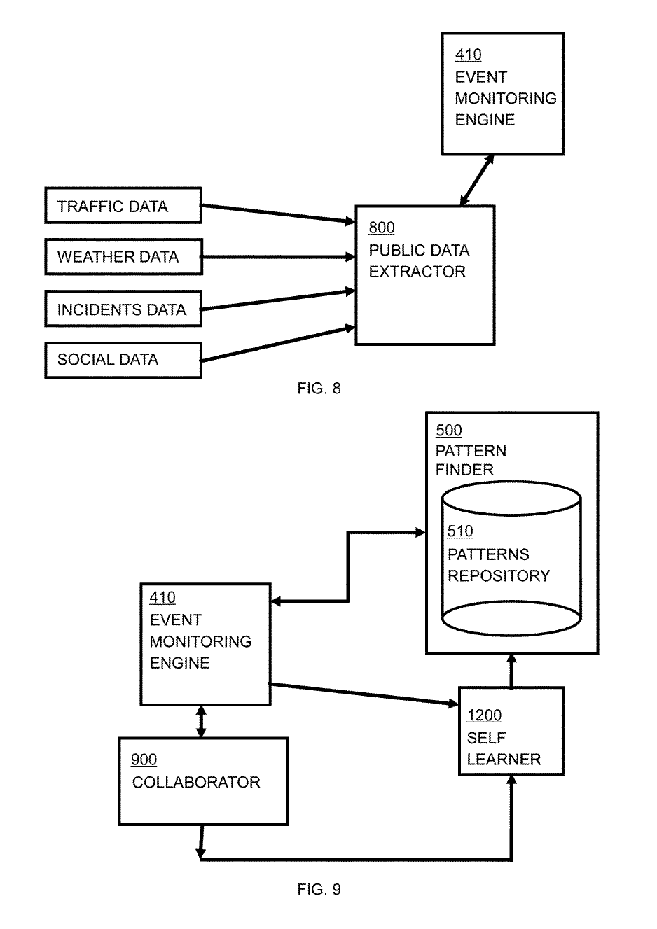

The content and purpose of dashboard 110, configurator 400, event monitoring engine 410, pattern finder 500, content extractor 700, public data extractor 800, collaborator 900, notification manager 1000, and self-learner 1200 will be described later with reference to FIGS. 4 to 10 and 12. Users/roles, social accounts, and events of configurator 400 will be described later with reference to FIG. 4. Event patterns, execution patterns, and behavioral patterns of pattern finder 500 will be described later with reference to FIG. 5. Emails, SMS, Facebook®, Twitter®, blogs, CDRs, and global positioning system (GPS) locations of content extractor 700 will be described later with reference to FIG. 7. Traffic data, weather data, incidents data and social data of public data extractor 800 will be described later with reference to FIG. 8.

In an embodiment of the present invention, the parameters to be monitored for an event are determined based on the role of the user who is assigned for the event. For example, a salesmen is assigned an event to meet the client at 10 am for a deal closure meeting. In this example, the following parameters will be monitored:

Event Details;

Salesmen Location with timestamp;

Call Data Record (CDR) between salesmen and client; and

Traffic Route between Salesmen Location and Client Location.

In another example, a developer is assigned an event to complete a design and to submit the design to a repository. In this example, the following parameters will be monitored:

Event Details;

Emails related to this event;

Internal Collaboration Activities;

Social Media Activities; and

Repository Updates.

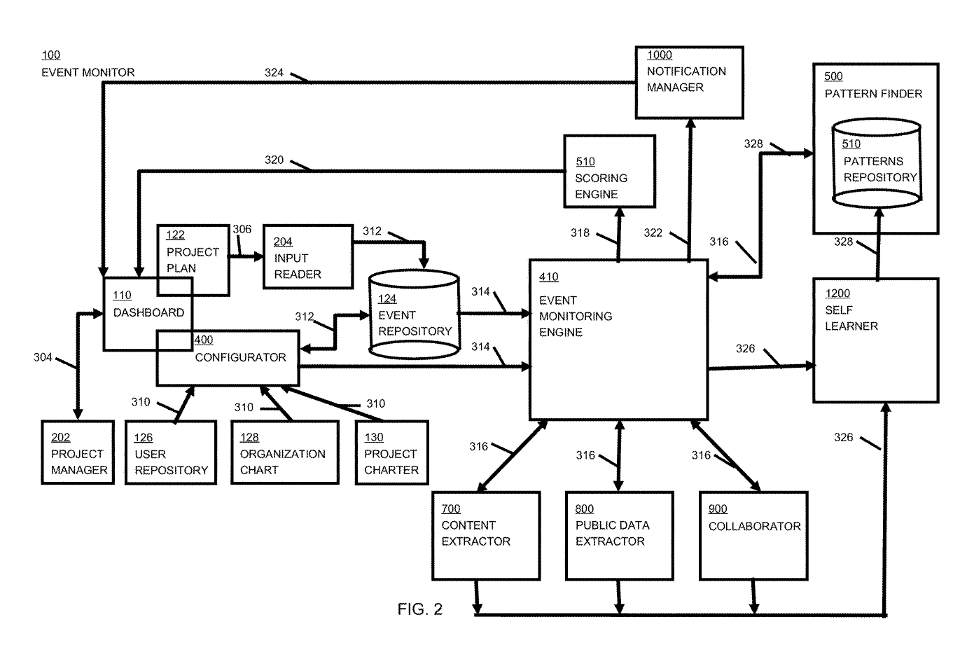

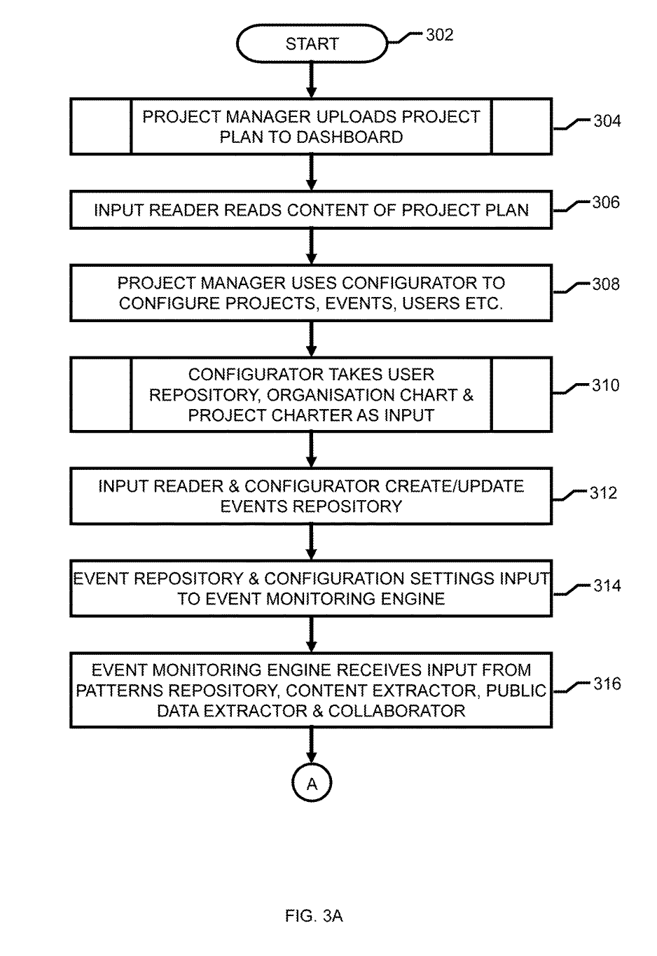

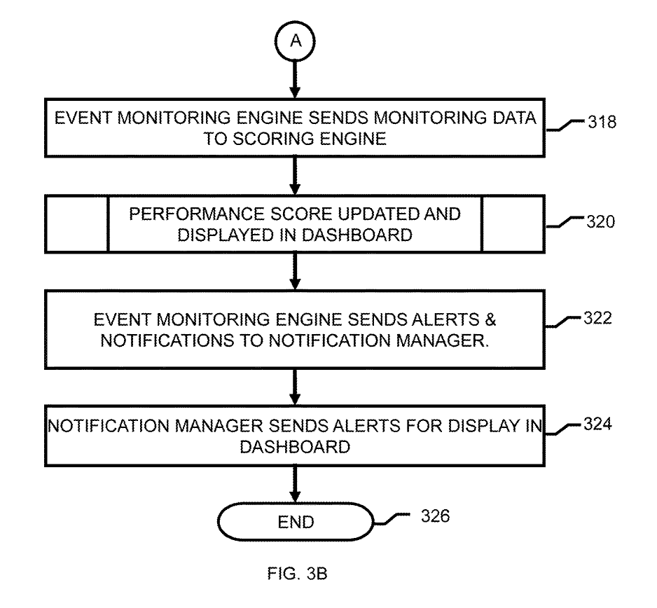

FIG. 2 shows data flows in the event monitor system in the embodiment of the present invention illustrated by FIG. 1. Each of the data flows will be described later with reference to FIG. 3. Reference numerals alongside each of the data flows correspond with aspects of FIG. 3. For ease of understanding, as each aspect of FIG. 3 may correspond to multiple data flows in FIG. 2, the same reference numeral may appear in FIG. 2 corresponding to multiple data flows.

FIGS. 3A and 3B are a flow chart depicting aspects of a method operable the embodiment of the present invention illustrated by FIG. 1. In an embodiment of the present invention, the method commences (302). A project manager 202 uploads the project plan 122 to the dashboard 110 (304). Input reader 204 takes the project plan 122 as input and reads its content (306). Project manager 202 uses configurator (e.g., 400 in FIG. 4) to configure the projects, events, users, and the like (308).

In an embodiment of the present invention, as illustrated in FIG. 3A, configurator 400 (FIG. 4) receives user repository 126, organization chart 128 and project charter 130 as input (310). In an embodiment of the present invention, configurator 400 is used to configure the events, users, roles, and assigned user's social media accounts, local collaboration tools accounts, event alarms/alerts, notification settings, and the like. This configured data is sent to the event monitoring engine 410 to consume and monitor based on its method. In an embodiment of the present invention, the configured data is sent to the event monitoring engine 410 as an XML, file. In an embodiment of the present invention, the user repository 126 is configured as an LDAP information service. In an embodiment of the present invention, configurator 400 prepares an XML configuration file with the details of the user from the user repository 126, details of the project plan 122, and organization chart 128.

In an embodiment of the present invention, configurator 400 creates the event repository 124 (312). Input reader 204 updates the information in the event repository 124 with the data contained in the project plan 122 (312). The event repository 124 contents are supplied to the event monitoring engine 410 (314). The configuration settings are supplied by the configurator 400 to the event monitoring engine 410 (314). In an embodiment of the present invention, the supplied configuration settings are contained in an XML configuration file.

Referring now also to FIG. 5, the event monitoring engine 410, based on the configuration data supplied at step 314, searches the patterns repository 510 and identifies the correct pattern to use based on the assigned event configuration (316). The patterns may include, but are not limited to, event patterns, execution patterns, and behavioral patterns. In an embodiment of the present invention, the configuration data comprises an XML file including details of the user, events, reporting structure, and the like, in order to monitor the project.

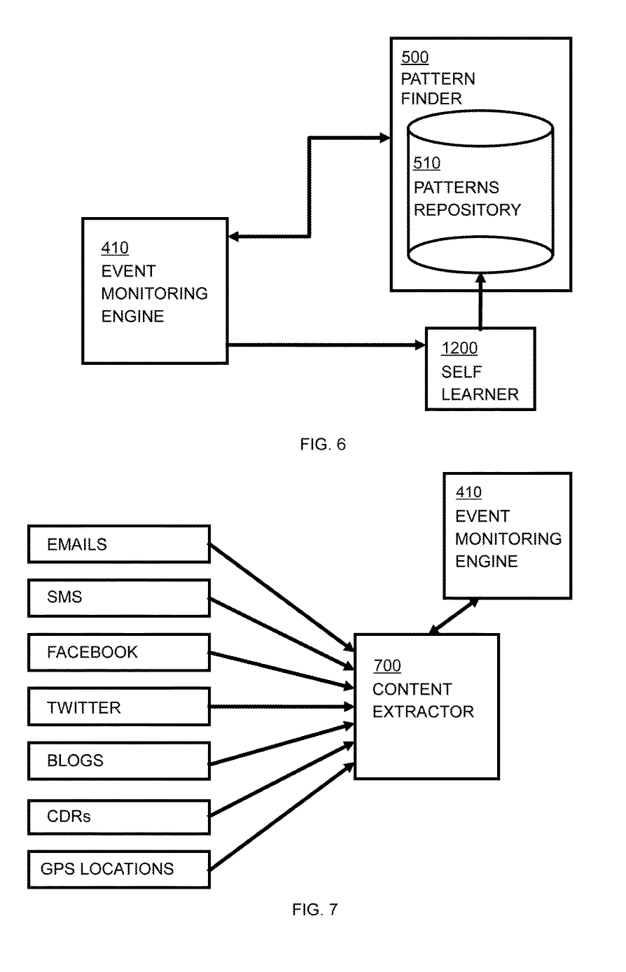

Referring to FIG. 6, in an embodiment of the present invention, the pattern finder 500 find patterns of user behavior, events and execution in the patterns repository 510.

Referring to FIG. 5, in an embodiment of the present invention, the event monitoring engine 410 retrieves the correct set of contents related to the assigned event and the assigned user's behavior from different repositories, such as the content extractor 700 and the public data extractor 800, based on the user configuration.

Referring to FIG. 7, in an embodiment of the present invention, the content extractor 700 extracts content from different media based on the nature of the event, the user, and his or her involvement. The content extractor 700 receives input from the event monitoring engine 410, telling it what content it should extract. Examples of media from which content may be extracted include, but are not limited to, e-mails, text messages (SMS), Facebook®, Twitter®, blogs, news feeds, Call Data Records (CDRs) between the user and other participants, and the geographical locations of the user through positioning systems.

Referring to FIG. 8, in an embodiment of the present invention, the public data extractor 800 extracts public data from public data sources such as traffic data, weather data, incident data, and social data, so as to be able to monitor the event being monitored.

Referring to FIG. 9, in an embodiment of the present invention, the event monitoring engine 410 receives input from collaborator 900 to monitor the assigned user's collaboration activities related to the event and to collect event feedback. This input may, for example, be received from the collaborator 900 continuously. Collaborator 900 monitors such areas as event activity updates in forums, event connections, topics in forums and wikis and participation in the community. In an embodiment of the present invention, this monitoring will be carried out continuously. The monitoring may be used to assess the user's performance in event execution. Using all of the above, the event monitoring engine 410 compares the user's performance with the pattern identified above.

Referring now to FIG. 3B, as well as FIG. 5, the event monitoring engine 410 calculates the user's event completion percentage and sends monitoring information to the scoring engine 520 to score the event performance (318). Scoring engine 520 compares the user's performance with similar events completed in the past, leverages the user's behavior to increase or decrease the score and provides the final score for the user's event completion. In an embodiment of the present invention, the event monitoring engine 410 sends the XML, configuration file to an application, which can, for example, reconfigure schedules and make critical path analysis projections for a project. As mentioned above, the configuration data includes an XML file including details of the user, events, reporting structure, and the like, in order to monitor the project. In an embodiment of the present invention, the scoring engine 520 updates the performance score and sends the updated performance score to the dashboard 110 for display against the associated event (320). Based on the performance score, the integrated event monitoring engine 410 updates the event repository 124 with the near real-time status of the event being monitored.

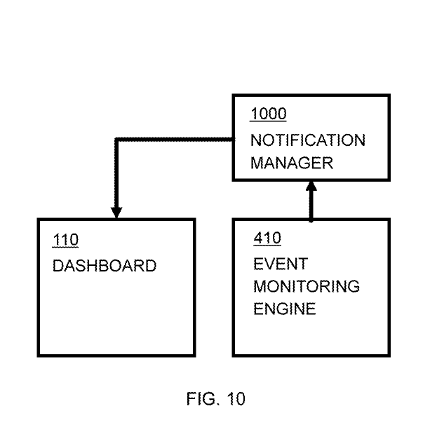

As depicted in FIG. 10 and FIG. 3B, event monitoring engine 410 sends alerts and/or notifications to notification manager 1000 (322). The notifications may include, but are not limited to, such items as event schedule overrun, cost overrun, scope creep, user's behavior, user's performance, and the like. In an embodiment of the present invention, event monitoring engine 410 may provide these notifications based on the settings or configurations provided by the planner/organization during the initial configuration process. In an embodiment of the present invention, these settings or configurations will have been added to the XML configuration file. While monitoring an event, the integrated event monitoring engine may look at a threshold value for when something should be done. As an example, a threshold of 2 days may be provided for event completion. While monitoring event completion, the event monitoring engine 410 looks for event completion dates, for example, +2 days to check the status of the event. If an event is not completed within the threshold, then event monitoring engine 410 informs the notification manager 1000 to release an alert notification to the appropriate project planner. Typically, event monitoring engine 410 will be monitoring many different areas, each potentially having its own threshold, in order to determine whether a notification should be sent to notification manager 1000. Before the conclusion of the method depicted in FIGS. 3A-3B (326), notification manager 1000 sends alerts to dashboard 110 for display (324).

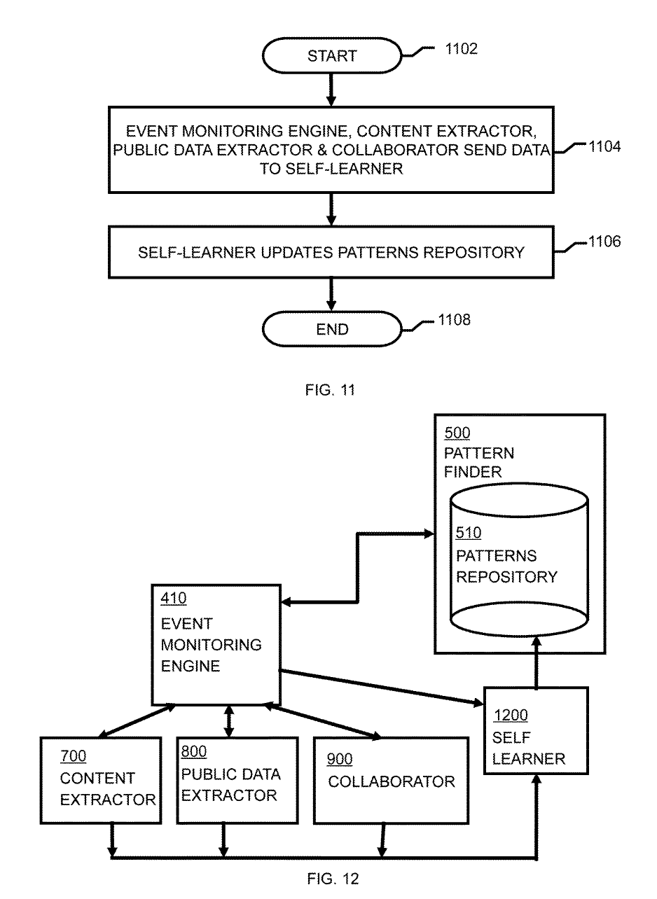

FIG. 11 shows a flow chart of periodic updates to the self-learner 1200 operable within an embodiment of the present invention including in the system depicted in FIG. 1. A method that includes aspects of some embodiments of the present invention commences (1102). Referring now to FIGS. 11 and 12, in an embodiment of the present invention, periodically, event monitoring engine 410, content extractor 700, public data extractor 800, and collaborator 900, send data to the self-learner 1200 (1104). Event monitoring engine 410 contains the current status of the event, which it may periodically sends to self-learner 1200. Content extractor 700 monitors the user's e-mail and social interactions related to the event and may periodically send this information to self-learner 1200. Public data extractor 800 monitors the public data which affects the user performance and may periodically sends this information to self-learner 1200. Collaborator 900 monitors the collaboration of the user and the event in internal forums, and may periodically send this information to self-learner 1200. Collaborator 900 may undertake event identification so as to monitor for certain events. Periodically, the self-learner 1200 compares the received monitored data with pattern data stored in the patterns repository 510 and enhances the event pattern with updated data (1106). In an embodiment of the present invention, the method concludes (1108).

According to an embodiment of the present invention, a system for monitoring events performed by a user in a project includes: a content extractor, which extracts relevant content from the user's communications associated with the project; a self-learner, which monitors the extracted relevant content; and a pattern finder, which periodically receives input from the self-learner, stores it in a patterns repository and detects patterns associated with user behavior, events and the execution of events.

In an embodiment of the invention, a method of monitoring events performed by a user in a project includes extracting relevant content from the user's communications associated with the project; monitoring the extracted relevant content and storing it in a patterns repository; and detecting patterns associated with user behavior, events and the execution of events.

In an embodiment of the invention, a computer program product for monitoring events performed by a user in a project includes: a computer readable storage medium having program instructions embodied therewith, the program instructions executable by a computer to cause the computer to: extract relevant content from the user's communications associated with the project; monitor the extracted relevant content; and detect patterns associated with user behavior, events and the execution of events.

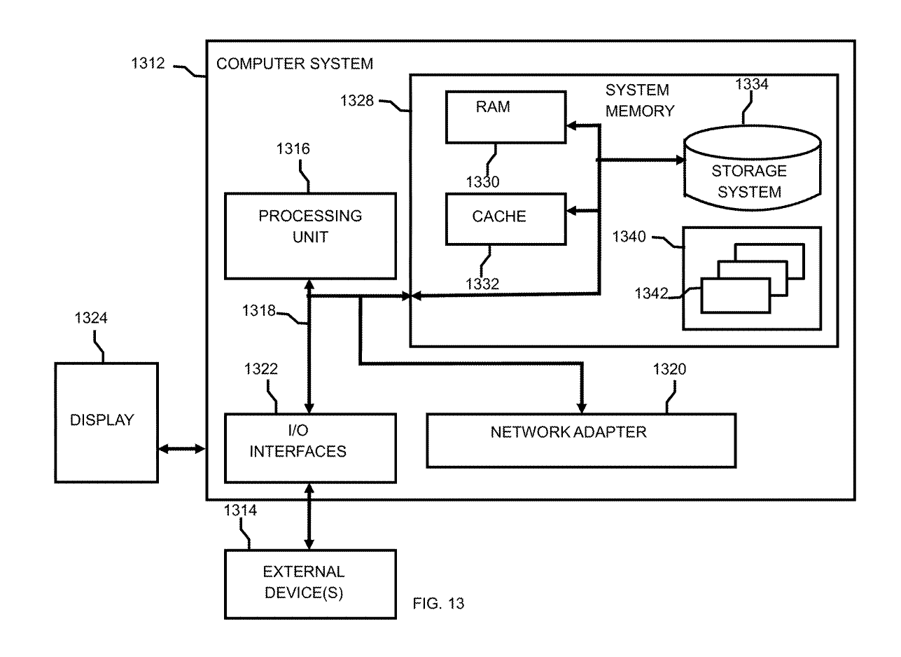

Referring now to FIG. 13, a schematic of an example of computing system is shown. Computing system 1312 is only one example of a suitable computing system and is not intended to suggest any limitation as to the scope of use or functionality of embodiments of the invention described herein. Regardless, computing system 1312 is capable of being implemented and/or performing any of the functionality set forth hereinabove.

Computer system/server 1312 is operational with numerous other general purpose or special purpose computing system environments or configurations. Examples of well-known computing systems, environments, and/or configurations that may be suitable for use with computer system/server 1312 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1312 may be described in the general context of computer system-executable instructions, such as program modules, being executed by a computer system. Generally, program modules may include routines, programs, objects, components, logic, data structures, and so on that perform particular events or implement particular abstract data types. Computer system/server 1312 may be practiced in distributed cloud computing environments where events are performed by remote processing devices that are linked through a communications network. In a distributed cloud computing environment, program modules may be located in both local and remote computer system storage media including memory storage devices.

As shown in FIG. 13, computer system/server 1312 is in the form of a general-purpose computing device. The components of computer system/server 1312 may include, but are not limited to, one or more processors or processing units 1316, a system memory 1328, and a bus 1318 that couples various system components including system memory 1328 to processor 1316.

Bus 1318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1312 typically includes a variety of computer system readable media. Such media may be any available media that is accessible by computer system/server 1312, and it includes both volatile and non-volatile media, removable and non-removable media.

System memory 1328 can include computer system readable media in the form of volatile memory, such as random access memory (RAM) 1330 and/or cache memory 1332. Computer system/server 1312 may further include other removable/non-removable, volatile/non-volatile computer system storage media. By way of example only, storage system 1334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1318 by one or more data media interfaces. As will be further depicted and described below, memory 1328 may include at least one program product having a set (e.g., at least one) of program modules that are configured to carry out the functions of embodiments of the invention.

Program/utility 1340, having a set (at least one) of program modules 1342, may be stored in memory 1328 by way of example, and not limitation, as well as an operating system, one or more application programs, other program modules, and program data. Each of the operating system, one or more application programs, other program modules, and program data or some combination thereof, may include an implementation of a networking environment. Program modules 1342 generally carry out the functions and/or methodologies of embodiments of the invention as described herein.

Computer system/server 1312 may also communicate with one or more external devices 1314 such as a keyboard, a pointing device, a display 1324, etc.; one or more devices that enable a user to interact with computer system/server 1312; and/or any devices (e.g., network card, modem, etc.) that enable computer system/server 1312 to communicate with one or more other computing devices. Such communication can occur via Input/Output (I/O) interfaces 1322. Still yet, computer system/server 1312 can communicate with one or more networks such as a local area network (LAN), a general wide area network (WAN), and/or a public network (e.g., the Internet) via network adapter 1320. As depicted, network adapter 1320 communicates with the other components of computer system/server 1312 via bus 1318. It should be understood that although not shown, other hardware and/or software components could be used in conjunction with computer system/server 1312. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, column-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
extracting, by a processing device, content from a user's communications associated with a project, wherein the project comprises events, and wherein the events are assigned to a user;
monitoring, by the processing device, the extracted content and storing the extracted content in a repository for patterns; and
detecting, by the processing device, in the extracted content, the patterns associated with at least one of: a behavior of the user, the events, or execution of the events.

2. The computer-implemented method of claim 1, wherein the extracting comprises:
extracting, by the processing device, the content from social media activity based on at least one of: a parameter relating the events, an identity of the user, or a role of the user related to the events.

3. The computer-implemented method of claim 1, wherein the extracting comprises:
extracting, by the processing device, the content from at least one of: an e-mail communication, a text message, a call data record, or a geographical locations provided by a positioning system.

4. The computer-implemented method of claim 1, further comprising:
extracting, by the processing device, relevant content from public data sources; and
obtaining, by the processing device, information related to collaboration by the user in at least one of: a forum or a wiki.

5. The computer-implemented method of claim 4, wherein the extracting comprises:
extracting, by the processing device, the content from public data sources, wherein one public data sources of the public data sources comprises: traffic data, weather data, or incident data.

6. The computer-implemented method of claim 4, further comprising:
searching, by the processing device, the patterns associated with least one of:
a behavior of the user, the events, or execution of the events, to identify one or more appropriate patterns to associate with an individual event of the events, wherein the individual event is to be monitored;
obtaining, by the processing device, a portion of the extracted content, wherein the portion is from at least one of: communication of the user related to the project, the relevant content from the public data sources, or the information related to collaboration by the user;
obtaining, by the processing device, the one or more appropriate patterns; and
utilizing, by the processing device, the portion and the appropriate patterns to generate a score representing performance of the user in performing the individual event.

7. The computer-implemented method of claim 6, further comprising:
receiving, by the processing device, an initial project plan for the project from a project manager;
configuring, by the processing device, the project, the events comprising the project, roles of users in the project, and social media identifiers for the project;
displaying, by the processing device, the score;
receiving, by the processing device, alerts and notifications; and
displaying, by the processing device, the received alerts and notifications.

8. A computer system comprising:
a memory; and
a processing device in communication with the memory, wherein the computer system is configured to perform a method, said method comprising:
extracting, by the processing device, content from a user's communications associated with a project, wherein the project comprises events, and wherein the events are assigned to a user;
monitoring, by the processing device, the extracted content and storing the extracted content in a repository for patterns; and
detecting, by the processing device, in the extracted content, the patterns associated with at least one of: a behavior of the user, the events, or execution of the events.

9. The computer system of claim 8, wherein the extracting comprises:
extracting, by the processing device, content from social media activity based on at least one of: a parameter relating the events, an identity of the user, or a role of the user related to the events.

10. The computer system of claim 8, wherein the extracting comprises:
extracting, by the processing device, the content from at least one of: an e-mail communication, a text message, a call data record, or a geographical locations provided by a positioning system.

11. The computer system of claim 8, the method further comprising:
extracting, by the processing device, relevant content from public data sources; and
obtaining, by the processing device, information related to collaboration by the user in at least one of: a forum or a wiki.

12. The computer system of claim 11, wherein the extracting comprises:
extracting, by the processing device, the content from public data sources, wherein one public data sources of the public data sources comprises: traffic data, weather data, or incident data.

13. The computer system of claim 11, the method further comprising:
searching, by the processing device, the patterns associated with least one of:
a behavior of the user, the events, or execution of the events, to identify one or more appropriate patterns to associate with an individual event of the events, wherein the individual event is to be monitored;
obtaining, by the processing device, a portion of the extracted content, wherein the portion is from at least one of: communication of the user related to the project, the relevant content from the public data sources, or the information related to collaboration by the user;
obtaining, by the processing device, the one or more appropriate patterns; and
utilizing, by the processing device, the portion and the appropriate patterns to generate a score representing performance of the user in performing the individual event.

14. The computer system of claim 11, the method further comprising:
receiving, by the processing device, an initial project plan for the project from a project manager;
configuring, by the processing device, the project, the events comprising the project, roles of users in the project, and social media identifiers for the project;
displaying, by the processing device, the score;
receiving, by the processing device, alerts and notifications; and
displaying, by the processing device, the received alerts and notifications.

15. A computer program product comprising:
a computer readable storage medium readable by a processing device and storing instructions for execution by the processing device for performing a method comprising:
extracting, by the processing device, content from a user's communications associated with a project, wherein the project comprises events, and wherein the events are assigned to a user;
monitoring, by the processing device, the extracted content and storing the extracted content in a repository for patterns; and
detecting, by the processing device, in the extracted content, the patterns associated with at least one of: a behavior of the user, the events, or execution of the events.

16. The computer program product of claim 15, wherein the extracting comprises:
extracting, by the processing device, content from social media activity based on at least one of: a parameter relating the events, an identity of the user, or a role of the user related to the events.

17. The computer program product of claim 15, wherein the extracting comprises:
extracting, by the processing device, the content from at least one of: an e-mail communication, a text message, a call data record, or a geographical locations provided by a positioning system.

18. The computer program product of claim 15, the method further comprising:
extracting, by the processing device, relevant content from public data sources; and
obtaining, by the processing device, information related to collaboration by the user in at least one of: a forum or a wiki.

19. The computer program product of claim 18, wherein the extracting comprises:
extracting, by the processing device, the content from public data sources, wherein one public data sources of the public data sources comprises: traffic data, weather data, or incident data.

20. The computer program product of claim 18, the method further comprising:
searching, by the processing device, the patterns associated with least one of:
a behavior of the user, the events, or execution of the events, to identify one or more appropriate patterns to associate with an individual event of the events, wherein the individual event is to be monitored;
obtaining, by the processing device, a portion of the extracted content, wherein the portion is from at least one of: communication of the user related to the project, the relevant content from the public data sources, or the information related to collaboration by the user;
obtaining, by the processing device, the one or more appropriate patterns; and
utilizing, by the processing device, the portion and the appropriate patterns to generate a score representing performance of the user in performing the individual event.
